(19) United States
(12) Patent Application Publication
(10) Pub. No.: US 2008/0245925 A1
(43) Pub. Date: Oct. 9, 2008

(54) Aircraft configuration

(75) Inventor: Kenneth F. Udall, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/000,881

(22) Filed: Dec. 18, 2007

(30) Foreign Application Priority Data
Jan. 9, 2007 (GB) 0700315.5

(51) Int. Cl. B64C 15/02; B64D 27/20

(52) U.S. Cl. 244/52; 244/55

(57) ABSTRACT

Some aircraft configurations have an engine arrangement comprising engines as part of an aft fuselage. In order to accommodate such engine arrangement positions, wings are rearwardly displaced compared to other aircraft configurations for balance across the fuselage. By creating empennage functions utilising the nacelle of engines as well as flaps to create rudder and elevator functions, it is possible to accommodate larger engine sizes more suitable for noise control with a reduced necessity for designed rearward movement of wings.

The present invention relates to aircraft configurations and more particularly to aircraft in which gas turbine and in particular turbo fan engines are located towards the aft of an aircraft.

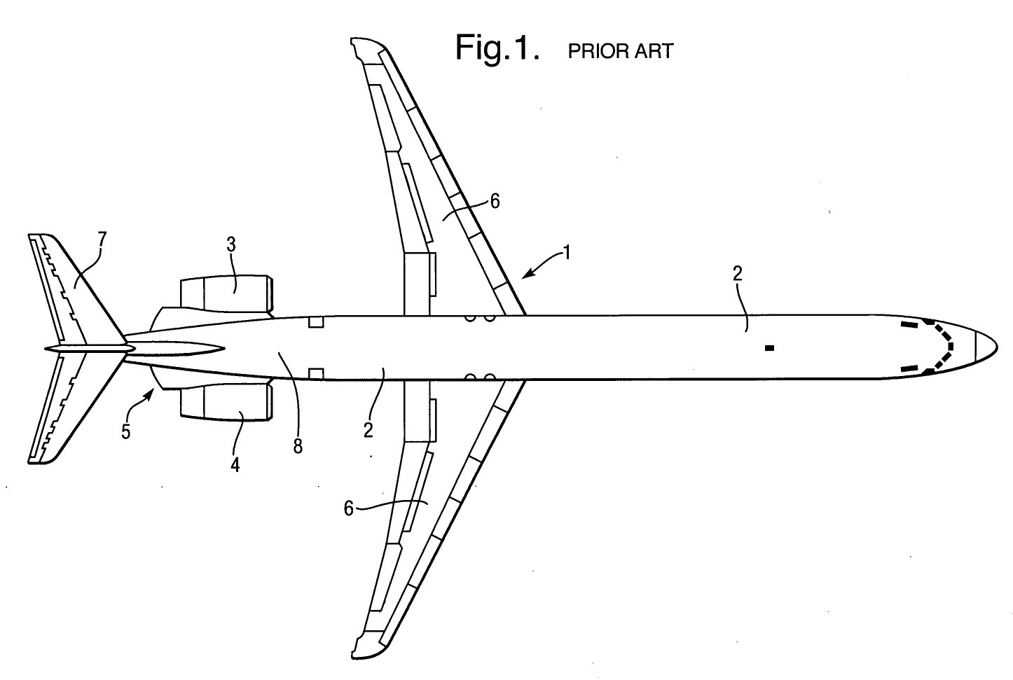

Numerous aircraft geometries are known and each has respective advantages and disadvantages. One orientation is to provide engines located towards the aft of an aircraft fuselage. FIG. 1 shows an aircraft configuration 1 in which a fuselage 2 incorporates an engine arrangement comprising engines 3, 4 towards a tail end 5 of the aircraft configuration. In order to balance engine 3, 4 weight, it will be noted that wings 6 of the aircraft configuration 1 are generally further aft than with other engine configurations. Furthermore, it will be noted that the tail plane 7 is mounted aft on the fin to maximise pitch leverage within the aircraft configuration 1. FIG. 1 provides a typical example of a rear fuselage engine arrangement. However it will be noted that the plan area of the engines and stub pylons appears similar to that of the tail plane, but the leverage and lift coefficient of the engines and pylons are lower than those of the tail plane.

A side view of the engines 3, 4 shows their relatively small size and the middle mounting with regard to the fuselage 2 means that these engines 3, 4 are substantially covered by the side area of the rear fuselage 8 between the engines such that the engines' contribution to yaw stability is relatively small. Nevertheless, the engine mounting position allows the fuselage to offer some protection from cross engine debris should a disk of either of the respective engines 3, 4 disintegrate.

By way of explanation rear fuselage engine aircraft require a relative rearward move of the wings 6 compared to other engine configurations to balance the weight of the engines 3, 4 against a longer forward fuselage 2a. Nevertheless, continuing pursuit of low noise and high efficiency results in a desire for larger fan sizes for the engines 3, 4 to increase by-pass flows. Larger fan sizes mean increasing engine 3, 4 weight and so further emphasising relative rearward movement of the wings 6. A shorter lever arm to the wings 6 and hence longer forward fuselage 2a results in a larger empennage requirement, that is to say rear part of the aircraft comprising a fin, rudder and tail plane adding to balance problems. Furthermore, use of the fuselage as a cross engine debris restraint may be advantageous with respect to engine operation but may cause concern to passengers located within a cabin portion towards this part of the fuselage 2 should there be a disk burst incident.

In accordance with aspects of the present invention there is provided an aircraft configuration comprising a fuselage with a tail end, the aircraft comprising an engine arrangement having an inlet and an outlet, the aircraft characterised in that the engine arrangement forms the tail end of the fuselage and provides empennage elements for aircraft stability and/or manoeuvring.

Typically, the empennage elements include a rudder and/or elevators.

Generally, the rudder and/or elevators are provided by flaps secured about the outlet. Typically, the flaps are independently actuatable. Possibly, the flaps are deployable/retractable. Generally, the flaps are operative on an engine exhaust and/or free flow through and about the engine arrangement in use. Generally, the empennage elements are part of an engine nacelle of the engine arrangement.

Typically, the engine arrangement incorporates a containment jacket and/or wall between respective engines of the engine arrangement to restrain debris. Typically, the engine arrangement comprises two gas turbine engines in a side by side configuration. Normally, the gas turbine engines are bypass gas turbine engines or propfan engines within a clearance shroud.

Typically, the engine arrangement is arranged sufficiently rearward within the fuselage to isolate the engine arrangement from location beside a cabin part of the fuselage.

Typically, the engine arrangement is configured such that any nozzle flows through respective outlets of engines in the engine arrangement are separated from each other.

Typically, the flaps allow variable nozzle area by displacement across and relative to the outlet. Potentially, the empennage elements forming an elevator can be utilised to provide a thrust reverser function or flow reversal with regard to the engine arrangement.

Typically, the flaps effectively define a rectangular exit nozzle for the outlet of the engine arrangement.

Possibly, the flaps are axially staggered.

Possibly, each flap defines a circular segment with a chordal edge secured to the outlet.

An embodiment of an aircraft in accordance with aspects of the present invention will now be described by way of example and with reference to the accompanying drawings in which:

FIG. 2 is a schematic front top perspective view of an aircraft in accordance with aspects of the present invention;

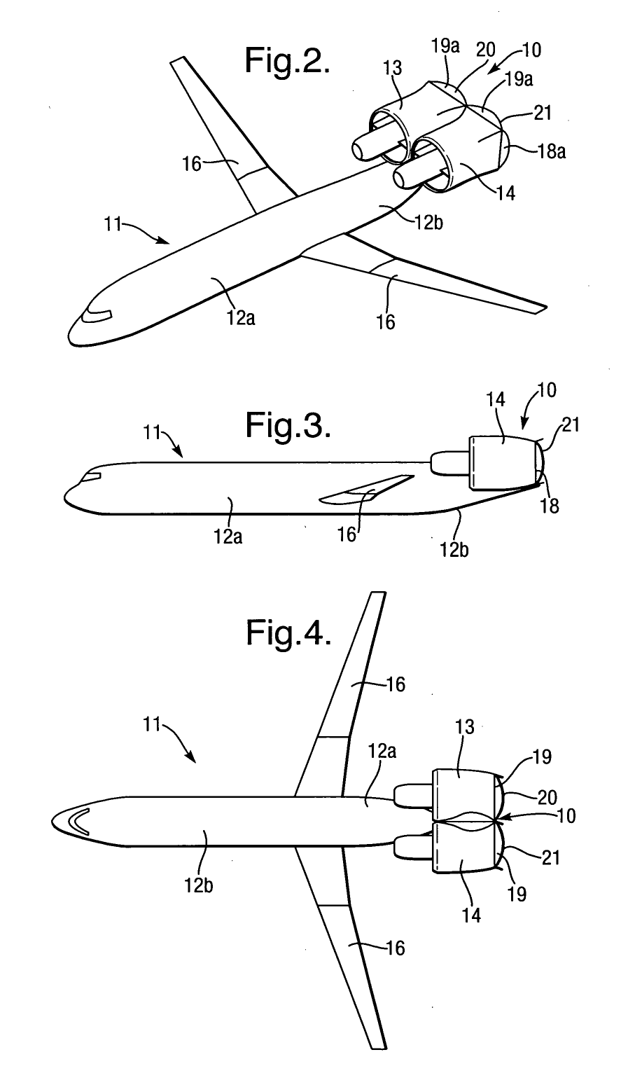

FIG. 3 is a side view of the aircraft depicted in FIG. 2;

FIG. 4 is a plan view of the aircraft depicted in FIGS. 2 and 3;

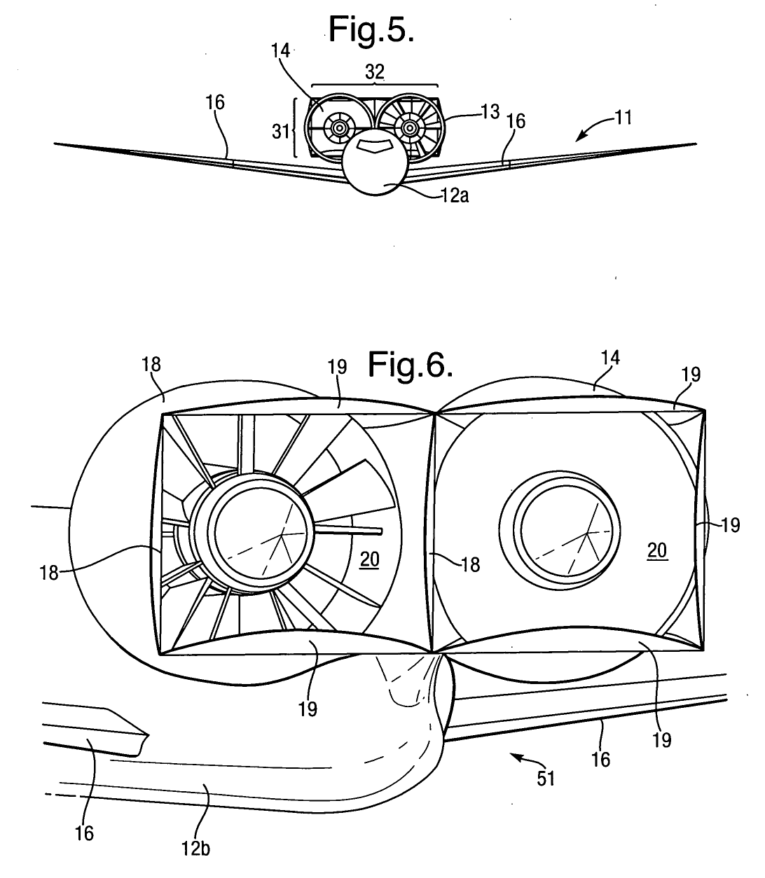

FIG. 5 is a front view of the aircraft depicted in FIGS. 2, 3 and 4; and,

FIG. 6 is a rear schematic perspective view of a tail end of an aircraft in accordance with aspects of the present invention.

As indicated above the desire to improve efficiency and achieve lower noise levels results in bypass engine configurations which have an increased fan size and therefore weight resulting, as illustrated in FIG. 2 with a further rearward movement of wings 16 relative to a fuselage 12. With prior arrangements of mounting engines upon a rear fuselage portion 12b just to the front of a tail plane it will be appreciated that the empennage of that rear part 12 will generally need to be dimensioned in order to balance the forward fuselage section 12a. In order to at least partially relieve this problem, an aircraft in accordance with aspects of the present invention is arranged to provide an engine arrangement 10 comprising engines 13, 14 as an integral part of the empennage, that is to say rear part of the aircraft fuselage 12b (fin, rudder and tail plane). The engines 13, 14 nacelles are integral with the fuselage 12b in order to create the empennage functions necessary for aircraft 11 operation.

As can be seen in FIG. 3, the engines 13, 14 will generally be such that the nacelle side area is slightly larger than that of a fin used in a typical aircraft 11 configuration. Furthermore, the engines 13, 14 provide a nacelle plan area as seen in FIG. 4 which again is slightly larger than a conventional tail plane necessary for the aircraft 11 to operate in use. However, these side and plan areas are sufficient to provide the empennage functions with regard to a fin and tail plane within the aircraft 11.

With regard to debris containment typically the engines 13, 14 will include a containment jacket around the whole engine arrangement 10 or at least a thick wall between the respective engines 13, 14 to provide protection. It will be appreciated that containment is required to accommodate a blade off or disk disintegration event which may result in blade fragments being propelled radially from the engines 13, 14. In such circumstances control surfaces of the fuselage 12 must be protected as well as occupants of a cabin within the fuselage 12, but it also important that debris from one engine 13, 14 does not damage or significantly damage the other engine 13, 14 such that the aircraft 11 will continue to operate. A further advantage of rearward positioning of the engines 13, 14 is that, as will be noted, the engines 13, 14 are effectively isolated from the passenger cabin of the fuselage 12 and so a simple containment jacket or wall between the engines 13, 14 will be adequate.

Of particular advantage with regard to the present invention is that the empennage elements of the nacelles forming the engines 13, 14 include flaps to act as rudders and elevators. These rudders and elevators will act on flow through and about the engines 13, 14 to provide the typical empennage control functions of an elevator and a rudder on an aircraft. It will be understood that the flaps forming the rudders and elevators are secured to a rear part of the nacelle of each engine 13, 14.

The flaps will provide maximum pitch and yaw leverage with regard to the aircraft 11 and will typically be independently actuatable. Advantageously, the flaps will operate on both engines 13, 14 exhaust jet flow as well as free stream flow through and about the engines, that is to say the flaps as part of the nacelle become control surfaces for empennage functions. Configuration of the nacelles and in particular the flaps forming the rudders and elevators will be such that the aircraft 11 can be operated by propulsion from one engine of the engines 13, 14 only forming the engine arrangement 10 with trim provided by appropriate adjustment of flaps forming the rudders and elevators as well as associated control surfaces within the wings and other aspects of the aircraft 11.

It is important that the respective outlets 20, 21 providing the nozzles from the engines 13, 14 are separated in order to avoid single engine failure nozzle over expansion causing instability.

As indicated above, the empennage elements to provide a rudder and elevators are achieved through flaps 18, 19. In the illustrations flaps 18 provide a rudder function and it will be appreciated that the nacelles will provide three rudders, one on each side and one centrally within the engine arrangement 10. The flaps 19 provide elevators and typically there will be four elevators above and below for each nacelle of each engine 13, 14.

In view of the above it will be appreciated that the empennage elements of the nacelles for the engines 13, 14 provide all the necessary stability control required of a tail plane and fin for the aircraft 11 to operate. A further advantage with regard to aspects of the present invention is that the empennage elements in the form of rudders and elevators can give independent nozzle variable areas for each engine 13, 14. By such variation in the nozzle area it will be appreciated that engine 13, 14 performance can be optimised, noise control can be achieved, a low pressure ratio fan working line control can be provided, fan flutter controlled and a number of other control variables changed as necessary.

If the engines 13, 14 are low bypass ratio turbo fan engines it will be understood that relatively large elevator flaps 19 can be deployed on aircraft 11 landing to provide a thrust reverser function. In such circumstances the flap will extend across the outlets for the engines 13, 14 in order to direct flow in a reverser direction. With a prop fan engine the elevators 19 can open, that is to say rotate outwards to provide an intake for flow reversal.

The flaps forming the rudders and elevators in accordance with aspects of the present invention thus allow engine geometry variations for engine performance optimisation etc., but it will also be understood that these flaps must provide a rudder and elevator function when required. In such circumstances the flaps 18, 19 may be retractable or variable in geometry to achieve these operational functions.

FIG. 5 provides a front on view of the aircraft 11 depicted in FIGS. 2 to 4. Engine 14 is shown in an operational state whilst engine 13 is shown stopped. FIG. 5 illustrates the raised position of the engines 13, 14 in order to create a side area with a width 31 sufficient to act as a fin for empennage functions in the aircraft 11. As indicated above, generally the area will be slightly larger than a conventional fin. Similarly, the engines 13, 14 will provide nacelles in order to create a plan area with a width 32 sufficient to provide a tail plane function in the aircraft 11. It will be noted that a stopped shrouded propfan has a relatively low internal nacelle blockage and hence lower nacelle flow disturbance relative to a turbofan engine.

FIG. 6 shows a tail end 51 of the aircraft as depicted in FIGS. 2 to 5. The engine 14 is operational whilst the engine 13 is shown in a stopped state. As indicated above, rudders are provided by flaps 18 which are shown displaced to the left of FIG. 6 whilst the elevator flaps 19 are shown upwardly extending and converging. It will again be appreciated that there is a low blockage for a stopped engine 13 so nacelle flow disturbance is limited and the nacelle/flaps are presented as control surfaces for the aircraft 11.

In view of the nature of the flaps 18, 19 it will be appreciated that a generally circular inlet to the engines 13, 14 is forced through a transition to a rectangular outlet nozzle 20, 21. This constraint is utilised in order to achieve the desired empennage functions.

In view of the convergent and divergent natures of the flaps 18, 19 it will be appreciated that it is advantageous if these flaps 18, 19 take a segment of a circle. In such circumstances as the flaps 18, 19 move relative to each other by providing circle segments with the chordal parts of those segments acting as the mountings to the outlet of the engines 13, 14 there is less likelihood of mutual contact and a minimisation with regard to end effects. However, where desirable, rectangular flaps 18, 19 may be provided but in such circumstances it will generally be necessary to provide axial staggering of the flaps 18, 19 to avoid contact with each other as they are displaced.

By combining the nacelle and empennage functions in an aircraft 11, it will be appreciated that generally a more compact, lighter and lower drag rear fuselage aircraft structure is typically achieved. By achieving a more compact and lighter structure it will also be understood that the necessity for rearward movement of the wings 16 is minimised again giving better empennage leverage and a reduced size in use.

In order to achieve the side and plan areas necessary for empennage fin and tail plane functions the aircraft configuration in accordance with aspects of the present invention is particularly suited to high bypass ratio low noise gas turbine engines or shrouded propfan engines. A further advantage of combining engine nacelle and empennage functions/elements is that the aircraft may have a reduced length and in combination with a high engine position reduce rotation case rear fuselage runway contact concern. Furthermore, the engine exhaust jet impingement upon the flaps forming the rudders in accordance with aspects of the present invention may improve rudder authority and responsiveness particularly at low speed such as with respect to ground manoeuvring.

By use of flaps in order to create elevators and rudders in accordance with aspects of the present invention it is possible that these flaps may be deployed outwards and possibly rearwards to entrain more jet flow and so reduce noise where noise as a result of jet velocity may be a problem. It will also be understood that these flaps may shield the jet flow noise. When not required for noise clearly the flaps acting as elevators and rudders may be retracted to reduce any drag effects. Thus, after take off the flaps acting as elevators and rudders may be retracted to improve engine power as noise control may be less of an issue during cruise.

With regard to turbo fans and large deployed flaps acting as elevators, a thrust reverser differential efflux could be biased to the lower jet at high speed to reduce “backward tipping” of the aircraft due to high engine placement relative to under wing mounted engines. However, at low speeds the efflux of the thrust reverser could be biased to the upper jet to reduce the effects of ground debris.

Modifications and alterations to aspects of the present invention will be appreciated by those skilled in the art. Thus, for example the single flaps utilised in order to create the rudder and elevator empennage functions for operation of an aircraft may be replaced with segmented flaps such that individual parts may be respectively displaced for engine nozzle jet control. As indicated above, generally the flaps will be flat and may be extended or retracted as required but a further aspect may be variations in terms of presented curvature in the flaps and differences in flap length across an edge of the nozzle to provide differing entrainment and other factors particularly with regard to engine noise control.

In summary the present invention is an aircraft having an engine arrangement 10 comprising engines 13, 14 and their nacelle(s) as an integral part of the empennage, that is to say rear part of the aircraft fuselage 12b (fin, rudder and tail plane). The engines 13, 14 nacelles are integral with the fuselage 12b in order to create the empennage functions necessary for aircraft 11 operation. The conventional fin, rudder and tail plane arrangement is removed. The operations of the conventional tail-plane are replaced in the present invention by an integrated empennage having moveable flaps 18, 19 for aircraft stability and/or manoeuvring. The flaps 18, 19 or empennage elements include a rudder 18 and/or an elevator 19 and are secured about the outlet(s) 20, 21 of the nacelles(s). There are numerous advantages of the present invention which include reducing weight of the aircraft, which is particularly apparent at the rear of the aircraft, meaning that the position of the wings is more forward than a conventional rear-fuselage engined aircraft. This provides improved balance and handling characteristics to an aircraft incorporating the present invention. The present invention also is aerodynamically better as there is a reduced overall wetted area reducing drag of the airframe. As the fans of the engines are within the nacelles there is a noise reduction benefit. Steering is also improved as the flaps work on the internal engine gas flows rather than purely ambient. The flaps may also be arranged to provide an area variation of the final exhaust. When flaps are positioned radially inwardly, the exhaust area is reduced to accelerate exhaust flow - this being beneficial at higher aircraft speeds. When flaps are positioned radially outwardly the exhaust area increases and the exhaust gas flows reduce thereby reducing the noise preferentially at take-off and landing.

1. An aircraft configuration comprising a fuselage with a tail end, the aircraft comprising an engine arrangement having an outlet, the aircraft characterised in that the engine arrangement forms the tail end of the fuselage and provides empennage elements for aircraft stability and/or manoeuvring.

2. An aircraft configuration as claimed in claim 1 wherein the empennage elements include a rudder and/or an elevator.

3. A configuration as claimed in claim 2 wherein the rudder and/or elevators are provided by flaps secured about the outlet.

4. A configuration as claimed in claim 3 wherein the flaps are independently actuatable.

5. A configuration as claimed in claim 3 wherein the flaps are deployable/retractable.

6. A configuration as claimed in claim 3 wherein the flaps are operative on an engine exhaust and/or free flow through and about the engine arrangement in use.

7. A configuration as claimed in claim 1 wherein the empennage elements are part of an engine nacelle of the engine arrangement.

8. A configuration as claimed in claim 1 wherein the engine arrangement incorporates a containment jacket and/or wall between respective engines of the engine arrangement to restrain debris.

9. A configuration as claimed in claim 1 wherein the engine arrangement comprises two gas turbine engines in a side by side configuration.

10. A configuration as claimed in claim 9 wherein the gas turbine engines are bypass gas turbine engines or shrouded propfan engines.

11. A configuration as claimed in claim 1 wherein the engine arrangement is arranged sufficiently rearward within the fuselage to isolate the engine arrangement from location beside a cabin part of the fuselage.

12. A configuration as claimed in claim 1 wherein the engine arrangement is configured such that any nozzle flows through respective outlets of engines in the engine arrangement are separated from each other.

13. A configuration as claimed in claim 3 wherein the flaps allow variable nozzle area by displacement across and relative to the outlet.

14. A configuration as claimed in claim 2 wherein the empennage elements forming an elevator can be utilised to provide a thrust reverser function or flow reversal with regard to the engine arrangement.

15. A configuration as claimed in claim 3 wherein the flaps effectively define a rectangular exit nozzle for the outlet of the engine arrangement.

16. A configuration as claimed in claim 3 wherein the flaps are axially staggered.

17. A configuration as claimed in claim 3 wherein each flap defines a circular segment with a chordal edge secured to the outlet.
